(19) United States
(12) Patent Application Publication
(10) Pub. No.: US 2009/0232030 A1
(43) Pub. Date: Sep. 17, 2009

(54) OVERLAY LINK CALCULATION DEVICE, CALCULATION METHOD AND PROGRAM THEREOF

(75) Inventors: Kazuya Suzuki, Tokyo (JP); Masahiro Jibiki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/720,736

(22) PCT Filed: Nov. 30, 2005
(86) PCT No.: PCT/JP05/22422

§ 371 Date: Jun. 1, 2007

(30) Foreign Application Priority Data
Dec. 1, 2004 (JP) 2004-347941

(51) Int. Cl. H04L 12/28

(52) U.S. Cl. 370/256; 370/254

(57) ABSTRACT

The overlay link calculation device which determines a link between nodes in an overlay network formed by layers of a higher order than a network layer, which includes a topology information obtaining unit which obtains topology information of the network layer and a link calculation which calculates an overlay link based on the obtained topology information.

### INCORPORATION BY REFERENCE

This application is based upon and claims the benefit of priority from Japanese patent application No. 2004-347941, filed on Dec. 1, 2004, the disclosure of which is incorporated herein in its entirety by reference.

### FIELD OF THE INVENTION

The present invention relates to an overlay link calculation device, and a calculation method and a program thereof and, more particularly, to an overlay link calculation device, and a calculation method and a program thereof for setting up an optimum overlay network on an existing IP (Internet Protocol) network for use in application layer multicast and the like.

### DESCRIPTION OF THE RELATED ART

Overlay network is a virtual network set up on an IP network or the like by a layer higher than a network layer. Each node forming the overlay network is referred to as an overlay network node. The overlay network is formed by a virtual link (referred to as overlay link) between overlay network nodes.

FIG. 11 is a block diagram of one example of a related art overlay network. Shown is an example in which an overlay network is set up on an IP network or the like. Problem in setting up an overlay network is between which overlay network nodes, an overlay link is to be set up. In the related art, adopted is a method of measuring a hop-count of a router and a delay between nodes to form an overlay link between nodes whose measurement value is small.

Detailed description will be here made with respect to application layer multicast (hereinafter represented as ALM) as one example of use of an overlay network. ALM is a technique which realizes multicast delivery by an application layer. In general, IP multicast as an IP level multicast function is well known and mounted on various kinds of routers. IP multicast, however, fundamentally involves several serious problems. They are, for example, difficulty in operation in an inter-domain, difficulty in assignment and management of multicast addresses and difficulty in access control and quality management. For these reasons, it is yet to be widely used in Internet in practice.

In ALM, duplication and multicast routing of a packet are realized by an application layer. Since communication between ALM nodes is executed by unicast, a router of a network layer only needs to execute unicast routing (see Patent Laying-Open No. 2002-232466 (Abstract, FIG. 2)).

In addition, one example of a network of this kind is disclosed in Japanese Patent Laying-Open No. 2003-234824. The technique is to provide a routing method of collecting information of a photonic router, information of a fiber link accommodated in the photonic router and information of an optical path set by the photonic router and seizing both fiber link network topology information and link network information of the set optical path to route both an IP packet accommodated in the optical path and an optical path accommodated in a fiber (see Japanese Patent Laying-Open No. 2003-234824 (paragraph 0010, FIG. 2)).

Also disclosed as another example is a technique of calculating a path by using the Dijkstra method (see Japanese Patent Laying-Open No. 8-178682 (see paragraphs 0003-0005, FIG. 1)).

In the above-described overlay network of the related art setting up method recited in Japanese Patent Laying-Open No. 2002-232466, an overlay link is determined based only on such information as a delay and a hop-count of a router between nodes.

FIG. 11 shows one example of an overlay link determined based on information about a hop-count by a related art method. Assume that 11˜15 in the figure represent overlay network nodes and 21˜24 represent common routers. The overlay network nodes 11˜15 each measure a hop-count up to other overlay network node. Two nodes whose measured hop-count values are first and second smallest are selected as adjacent nodes to form an overlay link for the adjacent nodes.

The node 11 in the figure selects the node 12 whose hop-count is 1 and the node 13 whose hop-count is 2 as adjacent nodes to form overlay links 31 and 33. Taking the same procedures with respect to the respective overlay network nodes 12˜15 leads to formation of an overlay network.

With reference to the figure, the overlay link 33 between the node 11 and the node 13 shares a link of a network layer with the overlay link 31 between the node 11 and the node 12 and with an overlay link 32 between the node 12 and the node 13. When realizing application layer multicast on the overlay network, the overlay link 33, which overlaps with the overlay links 31 and 32, is an unnecessary link.

Thus, with the related art methods, overlay links might be set up overlapping on a link of one network layer.

On the other hand, although the technique recited in Japanese Patent Laying-Open No. 2003-234824 is similar to the present invention in using topology information in networks whose layers are different, the technique recited in Japanese Patent Laying-Open No. 2003-234824 shows a method for handling topology information in networks whose layers are different “evenly”, while the present invention shows a method of forming an overlay link by using topology information of a lower-order layer, so that the technique recited in Japanese Patent Laying-Open No. 2003-234824 largely differs from the present invention in any of its object, structure and effect.

The technique recited in Japanese Patent Laying-Open No. 8-178682 does not disclose a means for solving the above-described problems either.

### SUMMARY OF THE INVENTION

An exemplary object of the present invention is accordingly to provide an overlay link calculation device, and a calculation method and a program thereof which enable an overlay link having no overlapping link to be determined.

An overlay link calculation device according to an exemplary aspect of the invention which determines a link between nodes in an overlay network formed by layers of a higher order than a network layer, which includes a topology information obtaining unit which obtains topology information of the network layer and a link calculation which calculates an overlay link based on the obtained topology information.

An overlay link calculation method according to an exemplary aspect of the invention is an overlay link calculation method of determining a link between nodes in an overlay network formed by layers of a higher order than a network layer, which includes a topology information obtaining step of obtaining topology information of the network layer and a link calculation step of calculating an overlay link based on the obtained topology information.

A program according to an exemplary aspect of the invention is a program of an overlay link calculation method of determining a link between nodes in an overlay network formed by layers of a higher order than a network layer, which causes a computer to execute the topology information obtaining function of obtaining topology information of the network layer and the link calculation function of calculating an overlay link based on the obtained topology information.

According to the present invention, an overlay link can be calculated based on obtained topology information.

### BRIEF DESCRIPTION OF THE DRAWINGS

FIG. 1 is a block diagram of a first exemplary embodiment of an overlay link calculation device according to the present invention;

FIG. 2 is a flow chart showing operation of the first exemplary embodiment of the overlay link calculation device according to the present invention;

FIG. 3 is a tree diagram for use in overlay link determination processing in the first exemplary embodiment of the present invention;

FIG. 4 is a diagram showing one example of an overlay link having no overlapping link according to the present invention;

FIG. 5 is a block diagram of a second exemplary embodiment of an overlay link calculation device according to the present invention;

FIG. 6 is a block diagram of a third exemplary embodiment of an overlay link calculation device according to the present invention;

FIG. 7 is a diagram showing one example of a tree diagram for use in overlay link determination processing in the third exemplary embodiment of the present invention;

FIG. 8 is a flow chart showing operation of the third exemplary embodiment of the overlay link calculation device according to the present invention;

FIG. 9 is a block diagram of a fourth exemplary embodiment of an overlay link calculation device according to the present invention;

FIG. 10 is a block diagram of a fifth exemplary embodiment of an overlay link calculation device according to the present invention;

FIG. 11 is a block diagram showing one example of a related art overlay network; and

FIG. 12 is a block diagram showing one example of a related art overlay link calculation device.

### DESCRIPTION OF THE EXEMPLARY EMBODIMENT

In the following, exemplary embodiments of the present invention will be described with reference to the accompanying drawings. First, an overlapping link will be defined. With overlay links forming a certain overlay network as x, a1, a2, . . . , sets made up of all the links of network layers forming these overlay links are assumed to be X, A1, A2, . . . , respectively. In this overlay network, when the set X is a sum-set formed of the sets A1, A2, the overlay link x will be referred to as an overlapping link.

### First Exemplary Embodiment

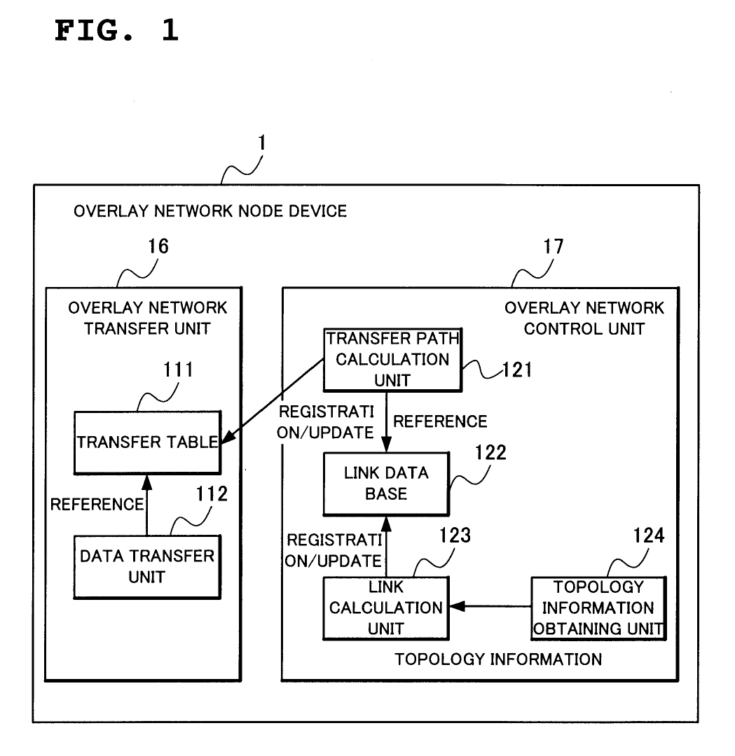

FIG. 1 is a block diagram of a first exemplary embodiment of an overlay link calculation device according to the first exemplary embodiment. The overlay link calculation device is formed of an overlay network node device 1 as one example.

In the figure, the overlay network node device 1 includes an overlay network transfer unit 16 and an overlay network control unit 17. The overlay network transfer unit 16 includes a transfer table 111 and a data transfer unit 112. The data transfer unit 112 receives data transferred on an overlay link and determines to which overlay link the data is to be transmitted based on the transfer table 111 to execute data transmission.

The overlay network control unit 17 includes a transfer path calculation unit 121, a link data base 122, a link calculation unit 123 and a topology information obtaining unit 124. The topology information obtaining unit 124 obtains topology information of a network layer from a device (not shown) having a topology information collection means provided outside of the overlay network node device 1.

The device having the topology information collection means here is a router or a network management system, for example. Router which transfers a packet of a network layer collects topology information of the network layer by using routing protocol in order to generate a path table for transfer. Network management system collects topology information of a network layer from each router in the network for the purpose of network management.

The link calculation unit 123 generates an overlay link by calculation based on topology information obtained from the device having the topology information collection means. The generated overlay link is stored in the link data base 122. The overlay link information stored in the link data base 122 has its transfer path determined by the transfer path calculation unit 121 and is registered in the transfer table 111 in the overlay network transfer unit 16.

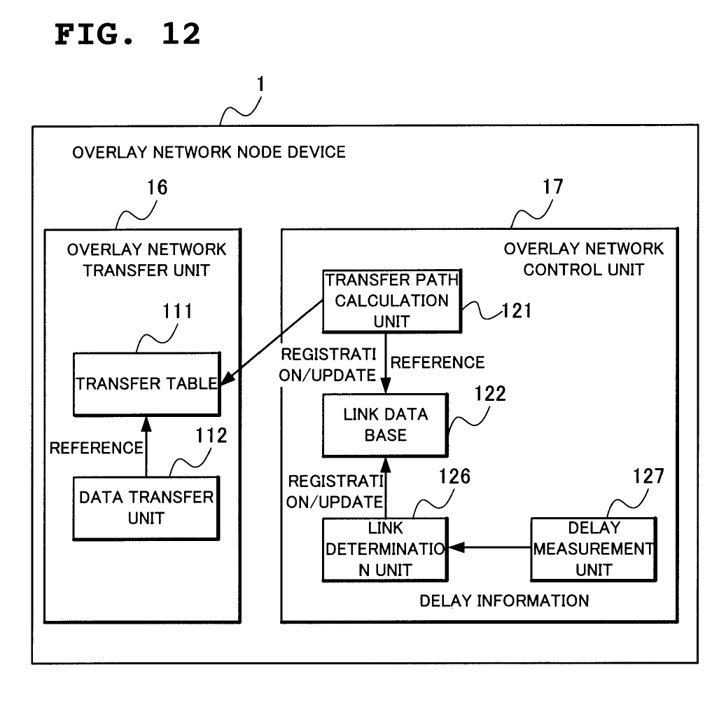

FIG. 12 is a block diagram of one example of a related overlay link calculation device. In the related structure shown in the figure, the overlay network control unit 17 includes a delay measurement unit 127 and a link determination unit 126. The first exemplary embodiment of the present invention differs in having not the delay measurement unit 127 but the topology information obtaining unit 124. In addition, while the related structure includes the link determination unit 126 for determining an overlay link based on delay information, the first exemplary embodiment of the present invention differs in including the link calculation unit 123 for calculating an overlay link based on the topology information.

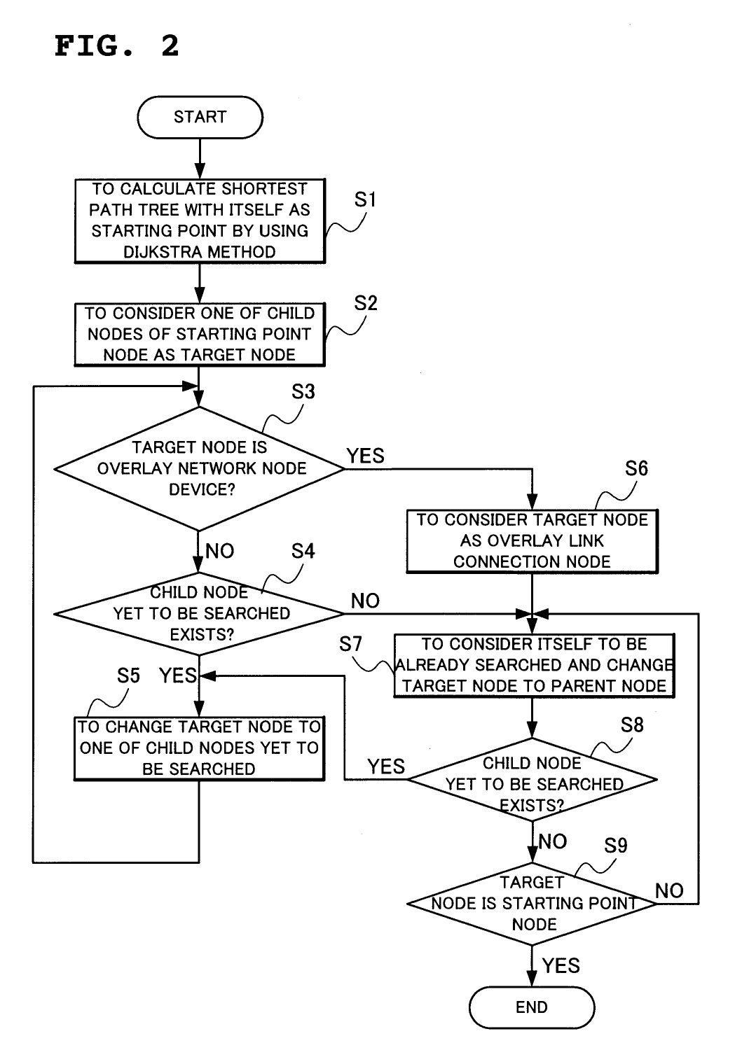

Next, operation of the first exemplary embodiment of the overlay link calculation device will be described with reference to FIG. 2. FIG. 2 is a flow chart showing operation of the first exemplary embodiment of the overlay link calculation device according to the present invention.

First, calculate a shortest path tree by using the Dijkstra method as a known algorithm based on topology information collected by routing protocol (Step S1).

The Dijkstra method is recited in the above-described Japanese Patent Laying-Open No. 8-178682. More specifically, in a case of forming a tree of links starting at a search starting link, when a certain link branches into a plurality of links, a path cost of a link of each branch is compared (a total sum of costs for reaching the link from the search starting link) with each other to realign the links in the ascending order of path costs and further continue searching starting at a link whose path cost is the lowest. Then, upon reaching a search ending link first, a path whose cost for reaching the search ending link is the lowest is then determined. Since search is sequentially continued starting at a link whose path cost is the lowest, a path which reaches the search ending link first will be a search path.

Here, at the time of deciding an overlay link at a certain overlay network node A, calculation is made with the node A as a starting point node of a shortest path tree. In the present first exemplary embodiment, since an overlay link formed of the overlay network node device 1 itself which executes calculation is determined, the device itself will be a starting point node.

In addition, the topology information here is a set of link information of a network layer, and link information is a pair of information about a cost value of a link and information about between which nodes the link is set up.

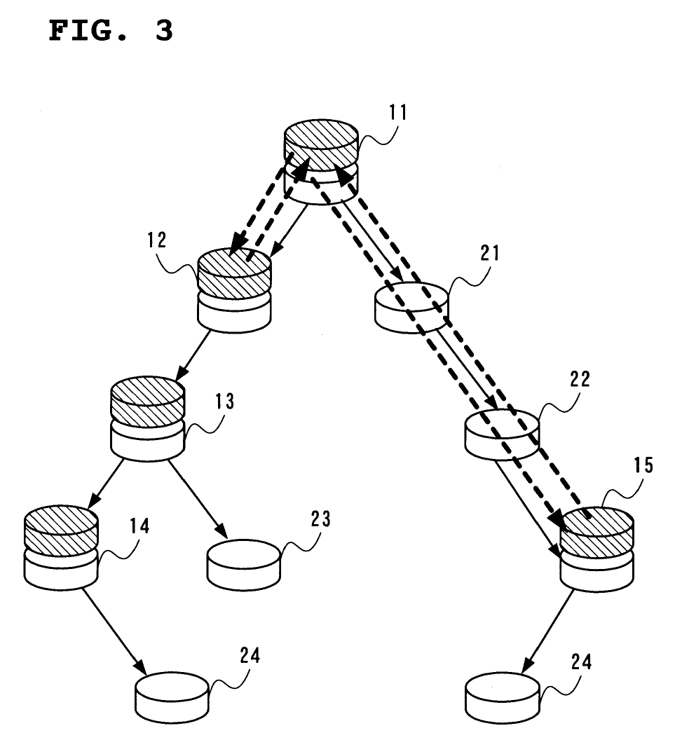

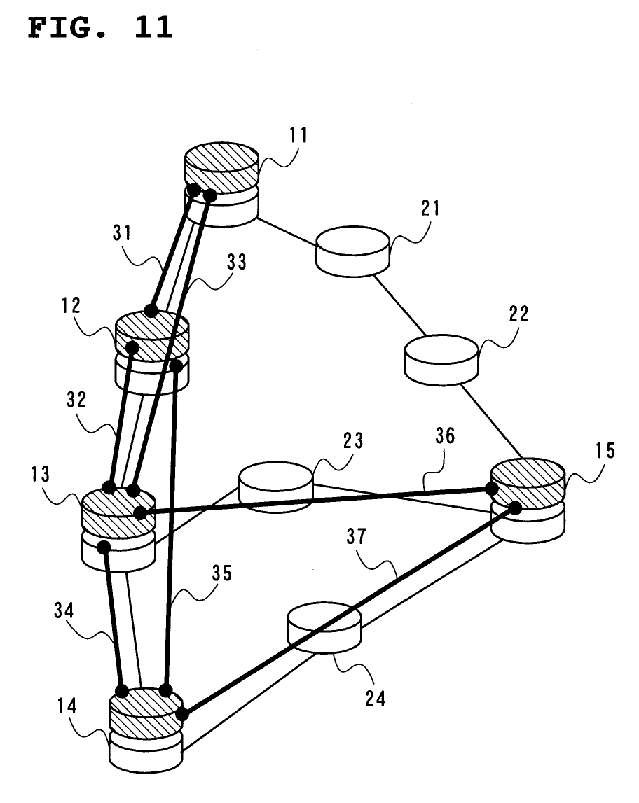

FIG. 3 is a tree diagram for use in overlay link determination processing in the first exemplary embodiment of the present invention. The figure shows a shortest path tree from a node 11 which is obtained by Step S1 when cost of each link is all 1 in the network shown in FIG. 11. More specifically, shown is that each link formed between nodes 11 and 12, between nodes 12 and 13, between nodes 13 and 14, between nodes 13 and 23, between nodes 14 and 24, between nodes 11 and 21, between nodes 21 and 22, between nodes 22 and 15 and between the nodes 15 and 24 is the shortest path.

Hereafter, in the form of search of the tree, an overlay network node to form an overlay link with the device itself (node 11) will be determined.

Consider one of child nodes of the tree starting point node calculated at Step S1 as a target node (Step S2). Next, check whether the target node is an overlay network node or not (Step S3). Unless the target node is an overlay network node, check whether the target node has a child node yet to be searched (Step S4). When there exists a child node yet to be searched, return to Step S3 with the child node as a target node (Step S5).

Next, description will be made of a case where the target node fails to have a child node yet to be searched. Change the target node to a searched state to consider its own parent node (immediately preceding node) as a target node (Step S7).

Subsequently, when the target node has a child node yet to be searched (Step S8), proceed to Step S5 or otherwise, proceed to Step S9. At Step S9, check whether the target node is a starting point node or not and when so, end the processing or otherwise, proceed to Step S7.

Next, description will be made of a case where the target node is an overlay network node device at Step S3. Consider the target node as an overlay link connection node (Step S6) to proceed to Step S7.

Next, description will be made of a specific example of operation of the first exemplary embodiment of the overlay link calculation device. First, based on topology information collected by the routing protocol at the topology information obtaining unit 124, calculate a shortest path tree with the node 11 itself as a starting point by the Dijkstra method by the link calculation unit 123 (Step S1).

The node 11 as a starting point node has the child nodes 12 and 21 (see FIG. 3). Then, the link calculation unit 123 first considers the child node 12 as a target node (Step S2).

Since the target node 12 is an overlay network node device (Step S3), consider the target node 12 as an overlay link connection node (Step S6).

Next, consider the target node 12 to be already searched to change the target node to a parent node (node 11) (Step S7).

Next, check whether the target node 11 has a child node yet to be searched (Step S8) and because the child node 21 yet to be searched exists, change the target node to the child node 21 yet to be searched (Step S5).

Next, since the target node 21 is not an overlay network device (Step S3), check whether the target node 21 has a child node yet to be searched (Step S4). Since the target node 21 has the child node 22 yet to be searched, change the target node to the child node 22 yet to be searched (Step S5).

Next, since the target node 22 is not an overlay network device (Step S3), check whether the target node 22 has a child node yet to be searched (Step S4). Since the target node 22 has the child node 15 yet to be searched, change the target node to the child node 15 yet to be searched (Step S5).

Next, since the target node 15 is an overlay network device (Step S3), consider the target node 15 to be an overlay link connection node (Step S6).

Next, consider itself, the target node 15, to be already searched and change the target node to the parent node (node 22) (Step S7).

Next, check whether the parent node 22 has a child node yet to be searched (Step S8) and because there exists no child node yet to be searched, check whether the target node 22 is a starting point node (Step S9).

Since the target node 22 is not a starting point node, return to Step S7. Then, consider itself 22 to be already searched and change the target node to the parent node (node 21) (Step S7).

Next, check whether the parent node 21 has a child node yet to be searched (Step S8) and since there exists no child node yet to be searched, check whether the target node 21 is a starting point node (Step S9).

Since the target node 21 is not a starting point node, return to Step S7. Then, consider itself 21 to be already searched and change the target node to the parent node (node 11) (Step S7).

Next, check whether the parent node 11 has a child node yet to be searched (Step S8) and because it fails to have a child node yet to be searched, check whether the target node 11 is a starting point node (Step S9).

Since the target node 11 is a starting point node, overlay link determination processing with the node 11 as a starting point ends.

As a result, the node 12 and the node 15 are obtained from the node 11 as overlay link connection partners.

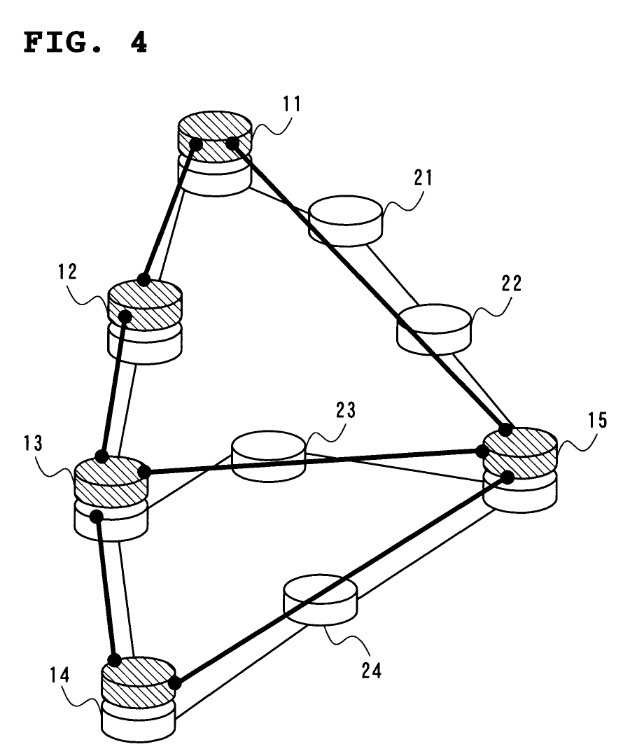

Execute the same processing as that described above with the nodes 12, 13, 14 and 15 as starting point nodes, respectively. As a result, such an overlay link having no overlapping link as shown in FIG. 4 is obtained.

### Second Exemplary Embodiment

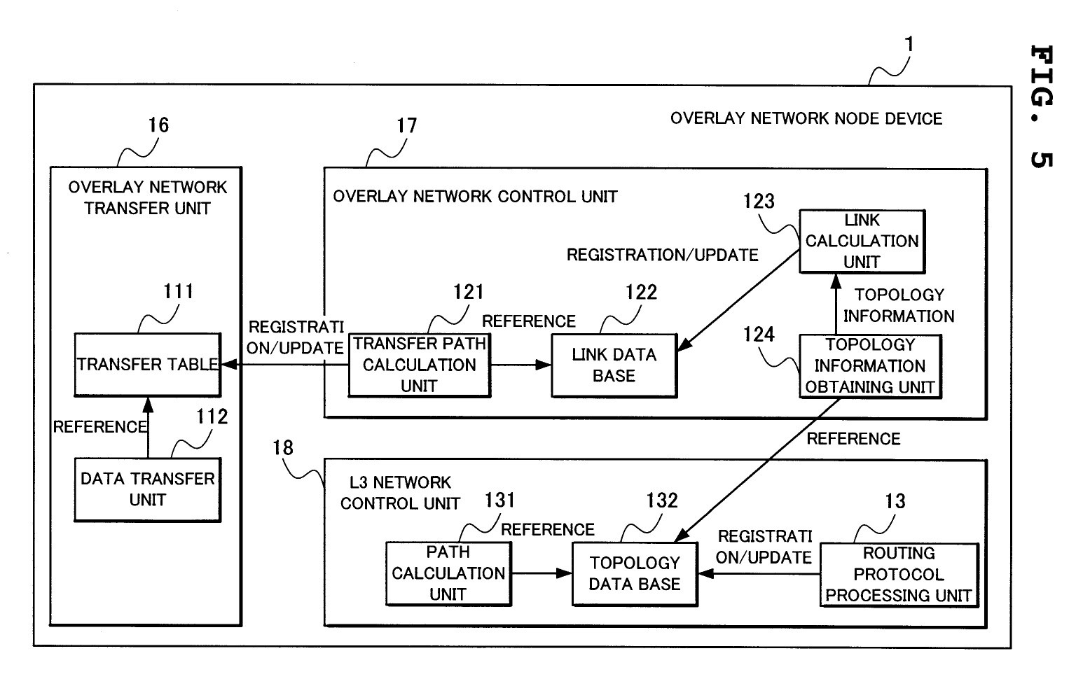

Next, detailed description will be made of a second exemplary embodiment of the present invention with reference to the drawings. FIG. 5 is a block diagram of the second exemplary embodiment of an overlay link calculation device according to the present invention. The overlay link calculation device is formed of the overlay network node device 1 as an example.

With reference to the figure, the overlay network node device 1 of the second exemplary embodiment includes an L3 network control unit 18 in addition to the components of the first exemplary embodiment.

The L3 network control unit 18 is structured to include a path calculation unit 131, a topology data base 132 and a routing protocol processing unit 133. With an adjacent node in a network layer, the routing protocol processing unit 133 collects topology information of the network layer by using routing protocol.

The collected topology information is stored in the topology data base 132. The path calculation unit 131 calculates path information in the network layer according to a calculation procedure determined for each routing protocol.

This differs from the first exemplary embodiment shown in FIG. 1 in that the overlay network node device 1 itself has the L3 network control unit 18 as a topology information collection means. The first exemplary embodiment requires a means for receiving and transferring topology information between the overlay network node device 1 and the device having the topology information collection means because the topology information collection means is provided externally. The present exemplary embodiment, however, requires no cooperation with an external device because the overlay network node device 1 itself is capable of collecting topology information.

### Third Exemplary Embodiment

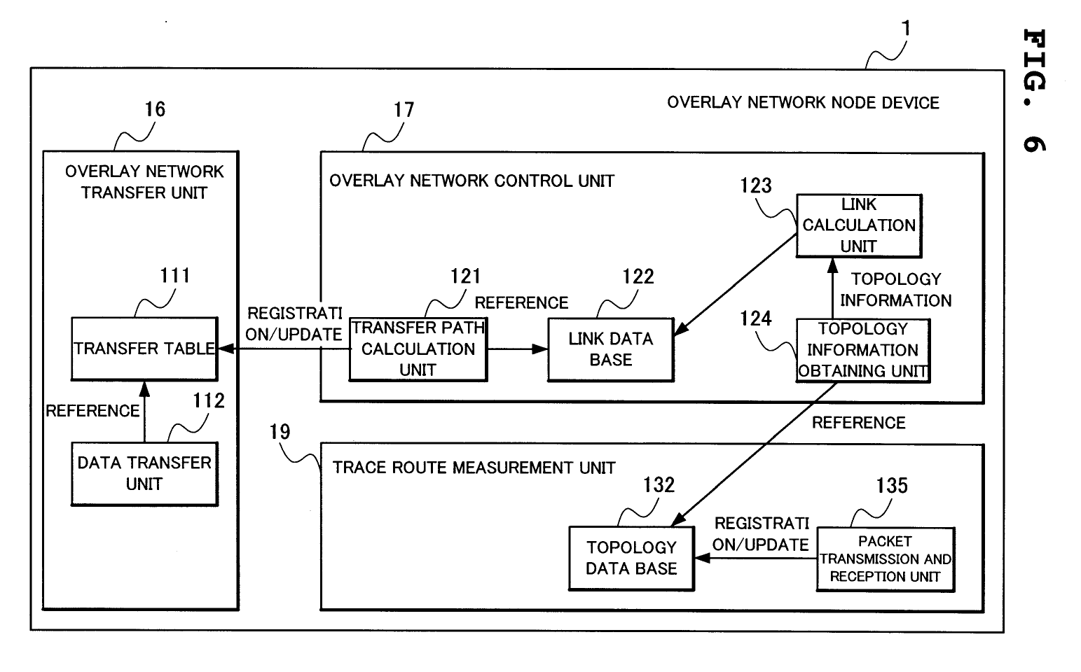

Next, a third exemplary embodiment of the present invention will be detailed with reference to the drawings. FIG. 6 is a block diagram of the third exemplary embodiment of an overlay link calculation device according to the present invention. The overlay link calculation device is formed of the overlay network node device 1 as an example.

With reference to the figure, the overlay network node device 1 of the third exemplary embodiment includes a trace route measurement unit 19 in addition to the components of the first exemplary embodiment.

The trace route measurement unit 19 includes the topology data base 132 and a packet transmission and reception unit 135. The packet transmission and reception unit 135 collects topology information by using a trace route. The collected topology information is stored in the topology data base 132.

Trace route is a known method of measuring a network path from itself directed to a host. Network path here represents information about through which node the network layer passes until reaching a destination.

The trace route measurement unit 19 measures a network path to all the overlay network nodes by using the trace route. As the topology information obtained from information about trace route measurement, only partial information can be obtained as compared with topology information obtained by using the routing protocol in the second exemplary embodiment.

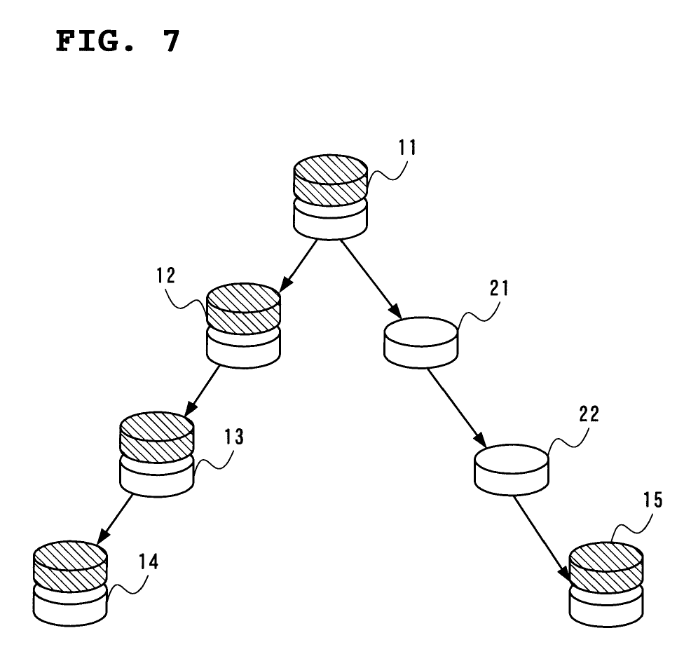

FIG. 7 is a diagram showing one example of a tree diagram for use in overlay link determination processing in the third exemplary embodiment. The figure shows topology information obtained when topology information is collected from the node 11. Thus, according to the present exemplary embodiment, it is impossible to obtain information related to a link between the nodes 13 and 23, a link between the nodes 23 and 15, a link between the nodes 14 and 24 and a link between the nodes 24 and 15 in the network of FIG. 3. Since a packet from the node 11 to other overlay network uses none of these links, no overlay link determination will be affected.

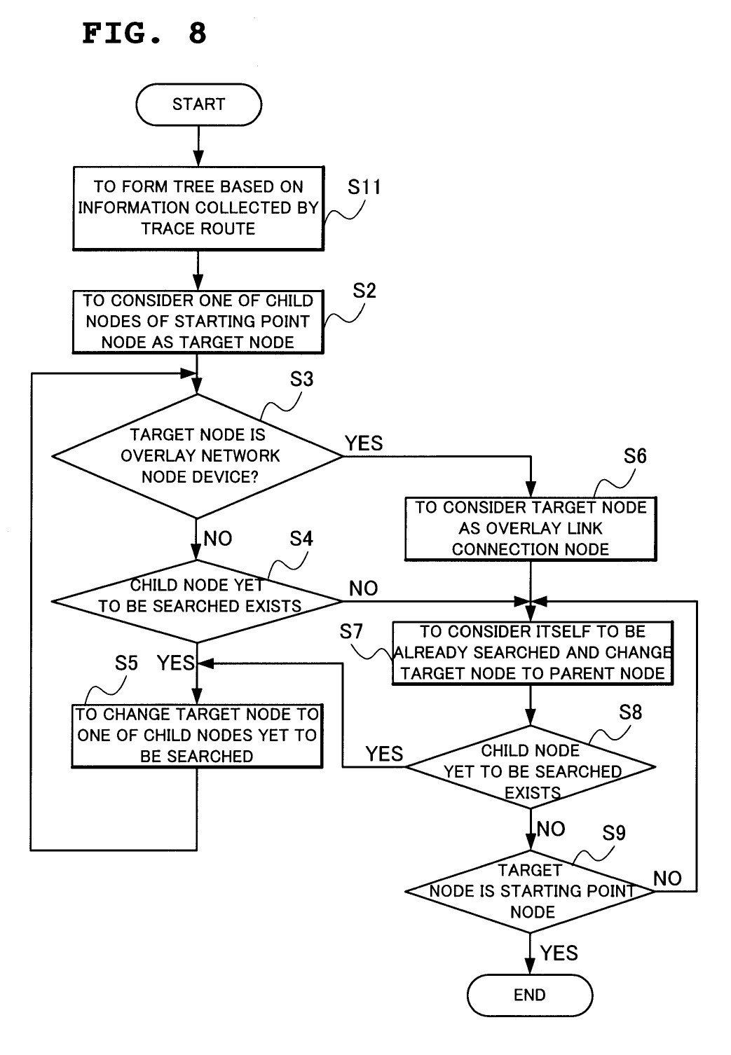

FIG. 8 is a flow chart showing operation of the third exemplary embodiment of the overlay link calculation device according to the present invention. Next, operation of the present exemplary embodiment will be described with respect to a difference from the operation of the first exemplary embodiment with reference to the figure. In the operation of the first exemplary embodiment (see FIG. 2), a shortest path tree is calculated by using the Dijkstra method (Step S1). On the other hand, in the present exemplary embodiment (see FIG. 8), a tree is formed based on information collected by using the trace route (Step S11).

In addition, the present exemplary embodiment differs from the second exemplary embodiment shown in FIG. 5 in that the topology information collection means is not the L3 network control unit 18 but the trace route measurement unit 19. The present exemplary embodiment is also applicable to a network in which no routing protocol operates.

### Fourth Exemplary Embodiment

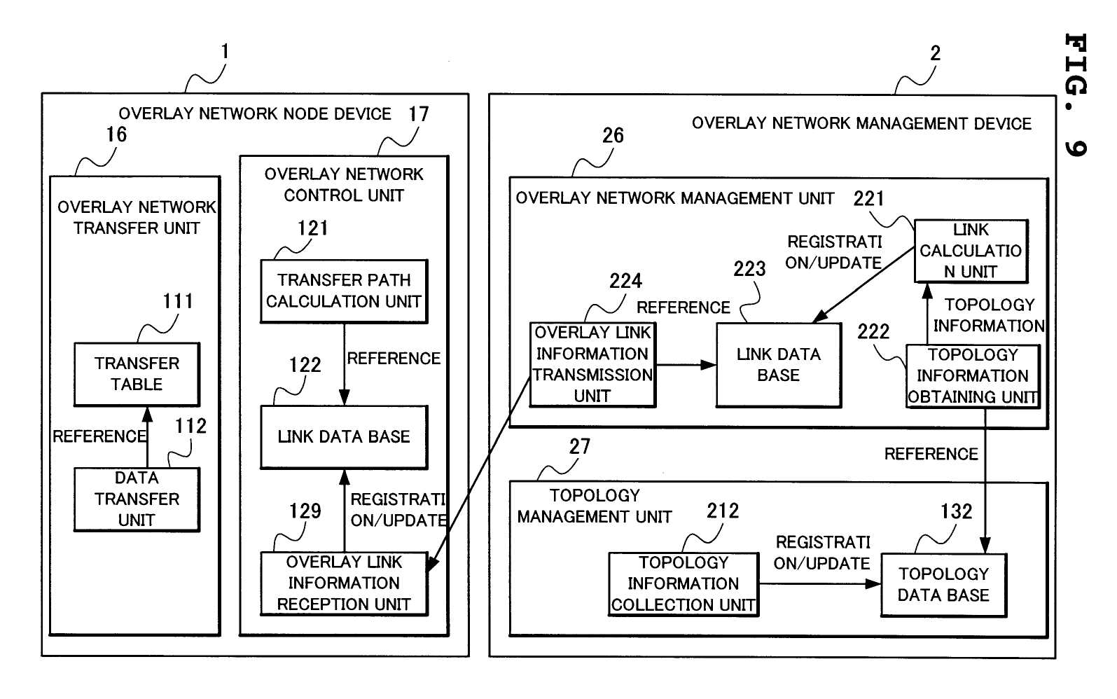

Next, a fourth exemplary embodiment of the present invention will be detailed with reference to the drawings. FIG. 9 is a block diagram of the fourth exemplary embodiment of an overlay link calculation device according to the present invention. The overlay link calculation device is formed of the overlay network node device 1 and an overlay network management device 2 as an example.

With reference to the figure, the overlay network node device 1 includes the overlay network transfer unit 16 and the overlay network control unit 17. The structure of the overlay network transfer unit 16 is the same as that of the first exemplary embodiment shown in FIG. 1.

The overlay network control unit 17 is structured to include the transfer path calculation unit 121, the link data base 122 and an overlay link information reception unit 129.

The overlay network management device 2 is structured to include an overlay network management unit 26 and a topology management unit 27.

The overlay network management unit 26 is structured to include a link calculation unit 221, a topology information obtaining unit 222, a link data base 223 and an overlay link information transmission unit 224.

The topology management unit 27 is structured to include a topology information collection unit 212 for collecting topology information from each router in the network by using protocol for network management such as SNMP (Simple Network Management Protocol) and the topology data base 132 for storing collected topology information.

The topology information obtaining unit 222 of the overlay network management unit 26 obtains information stored in the topology data base 132 of the topology management unit 27 and transfers the same to the link calculation unit 221. The link calculation unit 221 executes calculation based on the transferred topology information to generate an overlay link.

In the calculation of an overlay link by the link calculation unit 221, determination of an overlay link is made for each overlay network node in the network. In the method of the first exemplary embodiment, calculation is made with each overlay network node as a starting point node. The generated overlay link is stored in the link data base 223. The overlay link information transmission unit 224 transmits the overlay link information stored in the link data base 223 to each overlay network node device 1 in the network.

The present exemplary embodiment differs from the first exemplary embodiment shown in FIG. 1 in that the link calculation unit 221 and the topology information obtaining unit 222 are provided not in the overlay network node device 1 but in the overly network management device 2. The overlay network node device 1 needs not to execute link calculation processing whose load is large, so that it can adopt a structure specialized in the data transfer function in the overlay network.

### Fifth Exemplary Embodiment

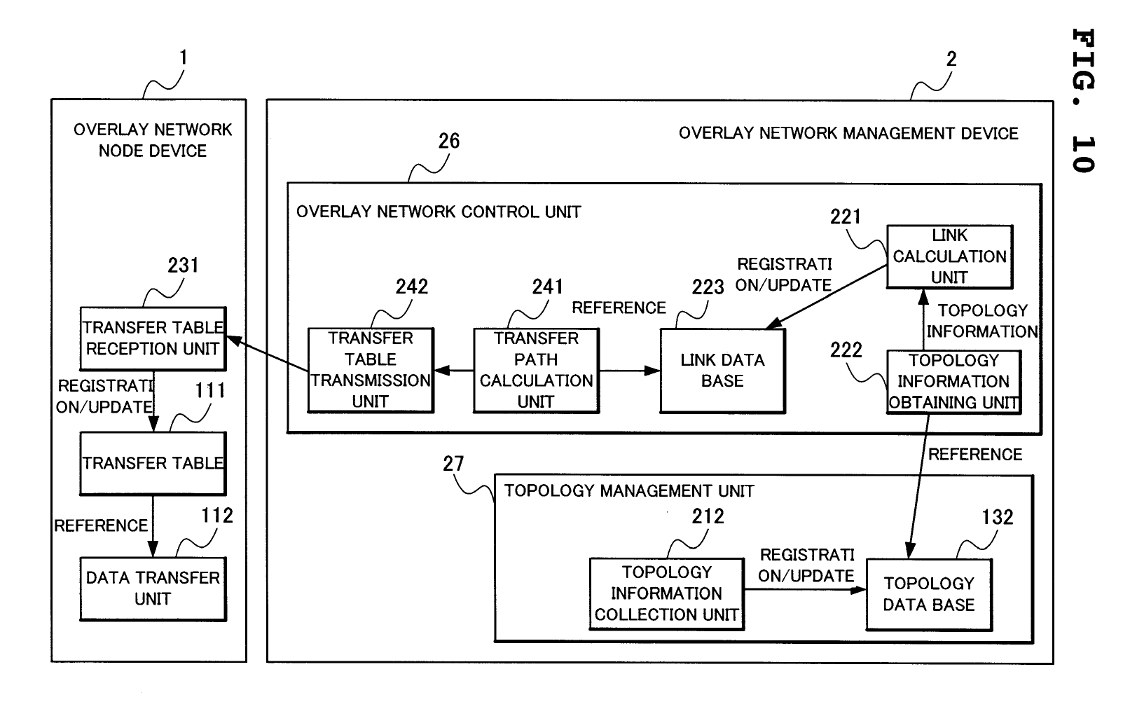

Next, a fifth exemplary embodiment of the present invention will be detailed with reference to the drawings. FIG. 10 is a block diagram of the fifth exemplary embodiment of an overlay link calculation device according to the present invention. The overlay link calculation device is formed of the overlay network node device 1 and the overlay network management device 2 as an example.

The overlay network node device 1 is structured to include a transfer table reception unit 231, the transfer table 111 and the data transfer unit 112.

The overlay network management device 2 is structured to include the overlay network control unit 26 and the topology management unit 27.

The overlay network control unit 26 is structured to include the link calculation unit 221, the topology information obtaining unit 222, the link data base 223, a transfer path calculation unit 241 and a transfer table transmission unit 242.

The topology information obtaining unit 222 of the overlay network management unit 26 obtains information stored in the topology data base 132 of the topology management unit 27 and transfers the same to the link calculation unit 221. The link calculation unit 221 executes calculation based on the transferred topology information to generate an overlay link.

In the calculation of the overlay link by the link calculation unit 221, determination of an overlay link is made for each overlay network node in the network. The calculation method is the same as that of the fourth exemplary embodiment. The generated overlay link is stored in the link data base 223.

With a transfer path determined by the transfer path calculation unit 241, the overlay link information stored in the link data base 223 is transferred to each overlay network node device 1 in the network by the transfer table transmission unit 242.

The topology management unit 27 is structured to include the topology information collection unit 212 for collecting topology information from each router in the network by using protocol for network management such as SNMP and the topology data base 132 for storing the collected topology information.

The present exemplary embodiment differs from the first exemplary embodiment shown in FIG. 1 in that the link calculation unit 221 and the topology information obtaining unit 222 are provided not in the overlay network node device 1 but in the overlay network management device 2.

The present exemplary embodiment also differs from the fourth exemplary embodiment shown in FIG. 9 in that the transfer path calculation unit 241 is provided not in the overlay network node device 1 but in the overlay network management device 2.

The overlay network node device 1 needs not to execute link calculation processing and transfer path calculation processing whose load is large, so that it can adopt a structure further specialized in the data transfer function in the overlay network than that in the fourth exemplary embodiment.

### Sixth Exemplary Embodiment

Sixth exemplary embodiment relates to a program of an overlay link calculation method. With reference to FIG. 1, the overlay network control unit 17 of the overlay network node device 1 has an external storage unit not shown in which a program of an overlay link calculation method is stored. The program is a program for causing a computer (the overlay network control unit 17) to execute the processing shown in the flow charts in FIG. 2 and FIG. 8.

The overlay network control unit 17 reads the program from the storage unit to control the topology information obtaining unit 124 and the link calculation unit 123 according to the program. Since the control contents have been already described, no further description will be made thereof here.

Since the present invention includes the above-described components, it is possible to determine an overlay link having no overlapping link.

More specifically, the first effect of the present invention is to save a link band in a network layer because an overlay network having no overlapping link can be set up.

The reason is that topology of the network layer is used at the time of determining an overlay link.

The second effect is to improve reliability of an overlay network by reducing the number of overlay links to be affected by a failure of a network layer.

Since an overlapping link shares a link of the network layer, a failure occurring in a link of the network layer might affect a plurality of overlay links. The overlay link determination method according to the present invention limits the number of overlay links to be affected by a failure of a certain link of the network layer only to one.

### INDUSTRIAL APPLICABILITY

As an application of the present invention, there exists the above-described application layer multicast (ALM). ALM is a technique for realizing multicast delivery by an application layer. ALM realizes packet duplication, multicast routing and the like by an application layer. Since communication between ALM nodes is executed by unicast, a router of a network layer only needs to execute routing of the unicast. It is therefore easy to apply the present invention to existing infrastructure.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. (canceled)

2. The overlay link calculation device according to claim 26, wherein said topology information obtaining unit obtains topology information of said network layer from an external topology information collection device.

3. The overlay link calculation device according to claim 26, further comprising topology information collection unit which collects topology information of the network layer to cause said topology information obtaining unit to obtain the information.

4. The overlay link calculation device according to claim 26, which is formed of an overlay network node device.

5. The overlay link calculation device according to claim 26, which is formed of an overlay network node device and an overlay network management device, wherein said topology information obtaining unit and said link calculation unit are provided in said overlay network management device.

6. The overlay link calculation device according to claim 3, wherein said topology information collection unit collects topology information of the network layer by using routing protocol.

7. The overlay link calculation device according to claim 3, wherein said topology information collection unit collects topology information of the network layer by using a trace route.

8. The overlay link calculation device according to claim 5, wherein said overlay network management device includes an overlay network management unit including said topology information obtaining unit and said link calculation unit, and a topology management unit for collecting topology information of said network layer to cause said topology information obtaining unit to obtain the information.

9. The overlay link calculation device according to claim 8, wherein said overlay network management unit includes a transfer path calculation unit for calculating a transfer path based on a calculation result obtained by said link calculation unit.

10. (canceled)

11. The overlay link calculation device according to any one of claim 2 through claim 10 and claim 26, wherein said link calculation unit determines an overlay link for each overlay node.

12. (canceled)

13. The overlay link calculation method according to claim 28, wherein at said topology information obtaining step, topology information of said network layer is obtained from an external topology information collection device.

14. The overlay link calculation method according to claim 28, further comprising the topology information collecting step of collecting topology information of the network layer to cause said topology information obtaining step to obtain the information.

15. The overlay link calculation method according to claim 14, wherein at said topology information collecting step, topology information of the network layer is collected by using routing protocol.

16. The overlay link calculation method according to claim 14, wherein at said topology information collecting step, topology information of the network layer is collected by using a trace route.

17. (canceled)

18. The overlay link calculation method according to any one of claim 13 through claim 17 and claim 28, wherein at said link calculation step, an overlay link is determined for each overlay node.

19. (canceled)

20. The program according to claim 30, wherein at said topology information obtaining function, topology information of said network layer is obtained from an external topology information collection device.

21. The program according to claim 30, wherein information of said network layer is obtained from an external topology information collection device.
The program according to claim 19, further comprising a topology information collecting function of collecting topology information of the network layer to cause said topology information obtaining function to obtain the information.

22. The program according to claim 30, wherein at said topology information collecting function, topology information of the network layer is collected by using routing protocol.

23. The program according to claim 21, wherein at said topology information collecting function, topology information of the network layer is collected by using a trace route.

24. (canceled)

25. The program according to any one of claim 20 through claim 23 and claim 30 through claim 31, wherein at said link calculation function, an overlay link is determined for each overlay node.

26. An overlay link calculation device which determines a link between nodes in an overlay network formed of a layer of a higher order than a network layer, comprising:
topology information obtaining unit which obtains topology information of said network layer, and
link calculation unit which calculates such an overlay link as generates no overlap on a link of the network layer based on obtained topology information.

27. The overlay link calculation device according to any one of claim 2 through claim 9, and claim 26, wherein said link calculation unit, with a child node of a starting point node of said shortest path tree as a target node, executes processing of checking whether said target node is an overlay link network node device, when said target node is said overlay network node device, considers the target node as an overlay link node connection node and when said target node is not an overlay network device, considers a child node yet to be searched as a target node to repeat said processing of checking whether said target node is an overlay link network node device, and
when no child node yet to be searched is left, repeats processing of considering a parent node as a target node until a child node yet to be searched is found, and when a child node yet to be searched is found, considers the child node as a target node to repeat said processing of checking whether said target node is an overlay link network node device.

28. An overlay link calculation method of determining a link between nodes in an overlay network formed of a layer of a higher order than a network layer, comprising: the topology information obtaining step of obtaining topology information of said network layer, and the link calculation step of calculating such an overlay link as generates no overlap on a link of the network layer based on obtained topology information.

29. The overlay link calculation method according to any one of claim 13 through claim 16 and claim 28, wherein said link calculation step, with a child node of a starting point node of said shortest path tree as a target node, executes processing of checking whether said target node is an overlay link network node device, when said target node is said overlay network node device, considers the target node as an overlay link node connection node and when said target node not an overlay network device, considers a child node yet to be searched as a target node to repeat said processing of checking whether said target node is an overlay link network node device, and when no child node yet to be searched is left, repeats processing of considering a parent node as a target node until a child node yet to be searched is found, and when a child node yet to be searched is found, considers the child node as a target node to repeat said processing of checking whether said target node is an overlay link network node device.

30. A program of an overlay link calculation method of determining a link between nodes in an overlay network formed of a layer of a higher order than a network layer, which makes a computer execute the following functions of:
a topology information obtaining function of obtaining topology information of said network layer, and a link calculation function of calculating such an overlay link as generates no overlap on a link of the network layer based on obtained topology information.

31. The program according to any one of claim 20 through 23 and claim 30, wherein said link calculation function, with a child node of a starting point node of said shortest path tree as a target node, executes processing of checking whether said target node is an overlay link network node device, when said target node is said overlay network node device, considers the target node as an overlay link node connection node and when said target node is not an overlay network device, considers a child node yet to be searched as a target node to repeat said processing of checking whether said target node is an overlay link network node device, and when no child node yet to be searched is left, repeats processing of considering a parent node as a target node until a child node yet to be searched is found, and when a child node yet to be searched is found, considers the child node as a target node to repeat said processing of checking whether said target node is an overlay link network node device.
